(19) United States
(12) Patent Application Publication
(10) Pub. No.: US 2005/0068223 A1
(43) Pub. Date: Mar. 31, 2005

(54) Analogue regenerative transponders including regenerative transponder systems

(76) Inventor: Geir Monsen Vavik, Jonsvatnet (NO)

Correspondence Address: LADAS & PARRY LLP, 224 SOUTH MICHIGAN AVENUE, SUITE 1200, CHICAGO, IL, 60604, US

(21) Appl. No.: 10/501,043

(22) PCT Filed: Jan. 9, 2003
(86) PCT No.: PCT/NO03/00004

(30) Foreign Application Priority Data
Jan. 9, 2002 (NO) 20020112

(51) Int. Cl. G01S 13/76

(52) U.S. Cl. 342/51

(57) ABSTRACT

In a transponder (19) for amplification of a received signal (60) into an antenna (1), to a signal (61) for retransmission, and where the retransmitted signal (61) possibly may have information superimposed, a quenched oscillator (5) is incorporated as amplifying element. The oscillator (5) is preferably of superregenerative type and exhibits negative resistance (30) for the received signal (60). Transponders according to the present invention may be introduced as system elements in a wireless or wire based network to work as intelligent or unintelligent connections in the network. The transponders can also be used in positioning systems.

### INTRODUCTION

The present invention concerns transponders of the general type as explained in the preamble of the appended claim 1, the application of such transponders in networks, as well as transponder systems in networks as given in the preamble of the appended claim 33.

### BACKGROUND

In a transponder system a radio frequency signal is transmitted to a transponder, which in turn retransmits the signal, often in modulated form, that is to say with superimposed information from the transponder. The purpose of a transponder may thereby be to convey or retrieve information related to the transponder in some way. Transponders normally are not expected to relay the incoming signal only with the original information. Some transponders work indirectly, others directly. In indirect retransmission, the signal is received and retransmitted in sequence. Retransmission may be desired to take place in a frequency band different from the band for received signal. Modern digital communication transponders, also named repeaters are known to digitally process the signal in then retransmit the information. This known technology works at the expense of complexity, cost and reduced information bandwidth.

Modern digital data communication has put forward a tremendous need for expanded and improved infrastructure in two-way access networks (last mile). It is partly true for long range (long haul) communication (first mile) as well. In satellite access networks there has been a continued search for inexpensive return channel capacity which, until now to a large degree has relied upon phone copper networks.

Recent years innovations of extending communication range, bandwidth and reliability has mostly dealt with novel applications of digital signal processing as well as improved approaches hereof. It seems forgotten or neglected that the analogue signal processing is and always will be the basic physical layer of any communication or transmission system. Despite all improvements in digital signal processing, the attainable results will always be ultimately limited by the analogue signal processing parameters. It may be concluded that vast improvements and new eras of the overall signal processing could be achieved if the analogue signal processing was paid equal attention.

In wireless applications, the path loss may vary typically from 80 to 130 dB.

In cable and wire bound applications the losses when trying to use higher frequency bands may vary typically from 30 to 80 dB. At the same time, isolation between circuits that are not optimally separated by intrinsic or introduced properties is only typically from 0 to 15 dB.

Without exceptions, modern transponders or repeaters for high frequency carrier digital transmission therefore do not utilise high, in-band or adjacent channel analogue in line gains. This type of duplex signal repetition will in most systems lead to instability and therefore cannot be realised using conventional technology. Textbooks therefore have no solutions for this type of problem. A typical modern problem of this kind is the up- and downstream amplification in Cable Modem systems. Here the problem is passing two signal directions through one coaxial cable and amplifying the signals at certain intervals. The solution to the problem using known technology is the so called bidirectional amplifiers that simply are one amplifier for one direction combined with a bypass filter for the other. The solution depends upon the frequency difference of the two signal directions being large to optimize stability resulting from the limited isolation between the two main ports of the device. In other cable and wire based applications there simply are no analogue gain solutions when high isolation between ports cannot be realised from one reason or the other. A typical example is a power circuit grid connection box where connections must enter and leave the power rails directly and thereby inhibit acceptable amplifier port isolation. Similarly, in power grid transformer stations, signal leakage via the low voltage circuits, the transformer and the medium voltage circuits prevent acceptable isolation. That is why all PLC (Power Line Communication) systems for internet access up till now do not use distributed analogue gain blocks to preserve signal to noise ratio. Distributed, cascaded gain blocks are fundamental in Cable Modem systems using low loss coaxial cables. In power grids with substantially higher attenuation, the need for corresponding gain blocks is no less and the technical challenges are in most respects substantially greater. Using analogue gain blocks in the power grid which also can be cascaded evidently was not thought of as realistic and practicable in PLC systems. The serious set-backs PLC access systems have suffered from the inability to produce reliable, large bandwidths and to comply with regulations demonstrate this. Known PLC access systems all use proprietary, switched symmetrical communication protocols. That implies also a further challenge to conventional gain blocks in that the gain block must be bi-directional. This has forced the PLC system designers to either use digital repeaters that reduce bandwidth or to use excessive excitation levels as well as relatively low carrier frequencies to obtain desired communication range. The switching nature of the signals just makes the emission problem more serious. Long delay times are also a typical disadvantage of these systems, making them less applicable to time critical applications, like IP telephony. This will especially be true for large systems with a high number of clients. PLC systems are characterized by the lack of ability to use as high a carrier frequency as the infrastructure will allow to improve emission and immunity characteristics, to enjoy the benefits of damped reflections and to reduce the in band group delay ripple. The lower the frequency used is in a PLC system, the more transfer characteristics will vary. These reasons combined can be thought of as the technical explanation why PLC access systems is so far did not gain noticeable use over the past 5 to 10 years.

In wireless systems, the situation is similar using symmetrically, switched systems requiring in-band bidirectional transponders or repeaters. With two or more antennas, a certain gain can be achieved. However, this gain is usually not nearly sufficient to compensate for losses plus achieve the required net gain. This is why modem uses have found no other way of solving related data transmission transponder or repeater problems than using technologies that reduce bandwidth and add high cost. The need for new core as well as system technologies that allow inexpensive and simple analogue high cascaded high frequency gains where high port isolation shows impractical is present in a large number of digital as well as analogue communication areas.

It has been shown that transponders may be realised as simple, injection locked oscillators. The use of these transponders has up till now been limited to obtaining a transponder modulation response, not to repeat a signal. The largest disadvantage of the injection locked oscillator is a very narrow lock frequency band and a very low sensitivity. There is a need for a technology, which improves the injection locked oscillator and expands the applications there of.

During the years that followed Fleming's invention of the vacuum tube and Armstrong's invention of the super regenerative detector, various attempts were made to utilise the technology in signalling networks. Some of them were patented. Most of them are characterised by using the regenerative circuits only for reception, some for obtaining modulated transponder responses as well. That includes some fairly recent patents based on solid state components. Very few may have proposed signal repetition or cascaded regenerative gain in which cases the described uses are outdated or very narrow, too limited for todays needs or contains serious discrepancies between the suggested solutions and some of the proposed uses. Common to all of them is at any rate the use of vacuum tube and not solid state gain elements. The use of vacuum tubes also prevented the technologies to prove reliable in field uses. Furthermore, using vacuum tubes limited or prevented the necessary refinement, repeatability, reliability and acceptable costs. Common to all of them are narrow credible communication bandwidths, and the lack of sharp band pass filtering of both input and output signals to meet today's standards for immunity and unwanted emission. Since then, the technologies have been forgotten or neglected. The industry has failed to acknowledge that modern solid state components with vastly improved specifications and cost factors could put Armstrong's invention in a completely new light. All this shows that there is an unsolved need for novel analogue gain block solutions in modern digital communication. It also shows that neglected and forgotten technology by novel applications and by using novel architectures based on modern component technology may contribute to meet this need.

In power line surveillance and communication (PLC) on the distribution circuits, where data communication is to include so called access networks for broad band distribution and other communication with clients, the communication range up till now would be limited to 100 to 300 meters due to signal losses. At these limiting distances unwanted emission could still pose serious problems. Line amplifiers are very expensive to realise and install and indirect repeaters reduce the data bandwidth. This is also true for high voltage cables where up till now only systems with extremely narrow bandwidths have been commercially available. Consequently known technology was limited to small systems that had to be linked by optical, copper, satellite or wireless communication. It is therefore a need for a novel technology which will allow the complete infrastructure of power grid networks to be tied together as cable or wire communication networks. With known technology there exists no solution, which in a simple, reliable, repeatable and inexpensive way can relay signals without complex arrangements passed embedded separations in a power network, i.e. a transformer station or distribution panels. There is a need for novel solutions that can both deliver analogue gain and bridge between parts of power grid structures. Existing systems for large bandwidth communication on power lines use the lower part of the RF spectrum to achieve acceptable attenuation levels and therefore suffer severe penalties from low frequency noise and variations that is significant on low voltage lines up to 20 MHz and in some parts of the power grid considerably higher. Power line noise exhibits both systematic and white noise characteristics, making the efficiency of various spread spectrum technologies variable and sometimes unpredictable. Typical of a power grid with a number of different circuits is that the lower region high frequency characteristics will vary tremendously, geographically and by time. PLC designers then, also were forced to use high signal excitation power levels causing unacceptable radiated levels. It exists therefore a need for a novel technology for analogue gain blocks in electricity networks used as access data networks employing simple methods requiring small or no modification of the infrastructure. Such technology would be applicable to medium and high voltage systems as well and can have large implications in wireless analogue and digital communication and broadcasting.

### SUMMARY OF THE INVENTION

It is therefore a main object of the present invention to provide transponders, repeaters and transponder or repeater systems, coupling arrangements, intercoupling arrangements as well as improvements thereof that facilitate substantial high frequency analogue cascaded gain to existing and new systems and infrastructure used or useful for communication where traditionally acceptable port isolation is impractical or intrinsically prevented. The object of the invention is also is to allow bidirectional gains, either in-band or in separate frequency bands for numerous high frequency applications. It is thus a significant object of the invention is to provide novel solutions that will improve existing communication infrastructure or facilitate communication using infrastructure that otherwise was not intended for use as communication infrastructure.

It follows that an objective of the present invention is to provide a very universal and at the same time inexpensive system for repeating RF signals, on a single or cascaded basis. This is realised through a single or a number of regenerative transponders or repeaters and coupling arrangements that are easy to install and power, and that require minor or no modification to the infrastructure and which therefore will meet requirements when the infrastructure by any reason cannot be substantially modified. It is thus an objective of the invention to facilitate long communication ranges and bandwidth where this would otherwise be impossible, impracticable or too expensive.

Another object of the invention is also to provide means of realising new types of communication systems based on the simplicity and high performance of the present invention that otherwise would not be possible or would be too costly to realise.

It is yet another object of the present invention to provide cascaded system regenerative gain blocks for unidirectional, bidirectional and multidirectional uses.

Another object of the present invention is to function both when frequency bands for up link and down link are overlapping as well as when they are separated or adjacent. It is further an object of the present invention that it should function both when signal dynamics up link and down link and in different directions are similar and when they are significantly different.

A further object of the present invention is to facilitate interconnections between transmission media and analogue system components. Also an object of the invention is to facilitate extensions of coaxial cable systems, fibre cable systems and hybrid fibre and coaxial systems (HFC) to the power line grids or other infrastructures available that resemble transmission mediums.

It is thus an object of the invention to facilitate new or improve existing RF signal paths for any existing communications or broadcast system. Examples hereof are the use of cable modem or long range Ethernet technology on power line grids including high voltage, medium voltage, low voltage, street lighting and control cables and wires. One more example of application of the invention is extending wireless LAN communication range or the similar.

It is also an object of the invention to provide some novel improved or alternative transponder solutions to radio navigation, radio positioning, radio direction finding, radio ranging, RFID and ECM uses as well

### THE INVENTION

Several of the objects of the invention are achieved, in a first aspect, with a transponder as given in the appended claim 1. Further, advantageous characteristics are given by the attached dependent claims.

Further stated objects, are achieved in a second aspect, with a transponder system as given in the appended claim 33.

Further characteristics of the system are given by the dependent, attached claims.

Completely independent of the way the first aspect of the invention is realised in detail, the principle of the invention may be described as a regenerative gain block, possibly of the super regenerative type, and is often preferred as a one port with negative resistance. Technically identical or similar to a quenched oscillator in the invention is a quenched or switched amplifier since stability criteria will not only be determined by internal characteristics but by the external parameters as well. A quenched amplifier as such therefore by definition is a quenched oscillator.

An evident characteristic of the invention are simple transponders that exhibit high conversion gain, and the transponder with corresponding performance may retransmit an amplified version of a received signal in the same frequency band or in a frequency shifted band and may work as a one-port amplifier and thus may be used to work directly in an uninterrupted signal path. It is thus well suited for sustaining the signal to noise ratio on a transmission line like a power cable without exceeding critical radiation levels. Advantages of the quenched oscillator transponder of the invention are the choices available to customise dynamic range and bandwidths. An example is using the whole bandwidth energy or all the useful sidebands which also adds redundancy. Another example is using a sideband or several sidebands selectively aided by filtering. An evident characteristic of the invention when using the super regenerative principle is the use of sharp band pass filters for output and input to aid modern requirements for immunity and unwanted emissions and wide communication bandwidth properties that may be aided by high quench frequencies. This requires fairly advanced filter designs where the highest attention must be paid to both the pass band transfer characteristics as well as the out of band transfer characteristics. This is important due to the high in band (channel) and adjacent band (channel) gains required.

The invention may be characterised by stray capacitance in components and structures often being a satisfactory link of the coupling of transponders in the invention and this is aided by the invention allowing higher frequencies used which increases the efficiency of stray couplings. In short, the large amplification associated with the present invention facilitates coupling arrangements otherwise inconceivable for technical or economical reasons. One example of such facilitation by the invention is in medium voltage installations is using the capacitive voltage probe of “Elastimold” power net stations and cable connections for signal transfers with high frequency carriers. Cables associated with Elastimold and subsequent systems may be called Pex cables and they resemble a coaxial cable structure with one or more inner conductor and an outer shield. The capacitive divider of the Elastimold and similar systems will show increased efficiency with frequency. The capacitive divider probe will often suffice as the RF signal sensor, but may be inefficient for excitation. An improved version of the capacitive divider coupling of the invention emerges when the outer shield is used as the coupling capacitor. This is further improved in the invention if a ferrite or iron powder sleeve or toroid core is clamped on the cable at a certain distance from the cable termination. Similarly in the invention, stray capacitance between the inner conductor and the common potential may be utilised as a coupling capacitor allowing the coupling of signals between the shield and the common potential. The invention may use a designated stray capacitor arrangement to achieve an efficient common high frequency potential and thus also aid suppression of unwanted common mode emission and immunity. The invention may utilise the RF signal being injected or sampled in a differential fashion using at least two cables or with ground as reference or a combination of the two.

The present invention therefore allows higher carrier frequencies to be used in power grid circuits than so called PLC (Power Line Communication) systems. By utilising the radiation loss for both the system energy on the cable and the RF interference signals picked up by the cable in combination with high carrier frequencies well away from power line noise, very low signal levels are required and the risk of disturbing other services is eliminated. RF interference on higher carrier frequencies can be minimised using redundancy in the frequency domain. The present invention allows for a large number of combinations to provide redundancy when it is required, i.e. on low voltage power lines in homes and buildings where the power line noise problem is significant. Redundancy can also be added in order to increase total system bandwidth by i.e. adding more communication channels. A further utilisation of redundancy may be accomplished by remotely or automatically controlling or switching properties of transponders or repeaters in the communication system for system adaptability to environment changes like i.e. interference.

The invention may utilise the frequency shifting or transposing characteristics of the super regenerative repeater (transponder) along with its high conversion gain. The frequency shift may then be equal to or a multiple of the quench frequency to either side of the centre frequency. Similarly, another novel solution of the invention using traditional but more costly and power consuming technology using a frequency converter or mixer in series with an amplifier where input and output of the mixer—amplifier chain is tied together and used as a one-port or where isolation between them is intrinsically seriously limited. The application hereof may be in cable or wire systems to increase noise tolerance, adaptation to varying cable types, lengths and losses using one-port or limited two-port amplification including a frequency shift. The principal function of both these implementations is identical and can be described as a frequency transposing one-port amplifier. The practical difference between them is that the super regenerative solution of the invention is independent upon adjacent channel selectivity whereas the mixer solution of the invention does require good filtering. These are important considerations when useful or available frequency bands are restricted.

Another characteristic of the invention is an improvement of the regenerative and super regenerative oscillator or amplifier combined with a bidirectional super heterodyne signal block. It consists of one or more frequency mixers with a common local oscillator. It may contain gain stages for both directions, the purpose being to compensate for losses and to assist obtaining the signal dynamics of the transponder. It allows the regenerative oscillator to be optimized in a frequency band different to the transponder frequency band, for example with respect to using a very high quench frequency for large transponder bandwidths. It may allow the transponder frequency band of the invention to be easily changed by altering the local oscillator frequency. It may contain filters on both the transponder frequency band of the invention and the regenerative device frequency band. It also increases dynamic range because quench frequency harmonics suppression is improved. It may also contain directional combiners to increase the allowable gain in the super heterodyne block. The super heterodyne net gain may be achieved by active mixers. When appreciable external port isolation is present, the transponder may be used as a two port separating the heterodyne gain for each direction. Unidirectional system gain, as with asymmetrical systems, may be served this way. Up and down links may be combined with dual or two transponders according to the invention. Yet another novel characteristic of the invention is when moderate high frequency gain is required. Then inherent added isolation by the mixers in the invention allows the regenerative oscillator to be omitted, thus by interconnecting the super heterodyne chains the super heterodyne gain itself will allow sufficient regeneration.

The super regenerative oscillator in the present invention works in a way so that without signal, during one quench cycle, it does not reach full oscillation conditions. The regeneration range is determined mainly by the bias conditions and the quenching function. The most significant property of the quenching function is the quench frequency. At sub Hertz frequency (1/f), regeneration is moderate and has poorer self stabilisation. At very high quench frequency gain will deteriorate while stability remains good. At medium quenching frequencies, gain is high and stability is good, but bandwidth properties may not be useful. The present invention facilitates an optimum combination of these factors. The possibility of using higher carrier frequencies on longer, high current and high voltage shielded power cables is also facilitated by the present invention. The advantage here being avoidance of low frequency region noise as well as reduced group delay ripple within the communication band. Less variations in transfer characteristic is one of the great advantages of being able to use as high carrier frequencies as possible on both large and small size power cables. The invention facilitates this in many ways; one is large available amplification gains and the implicit possibility of introducing gains in uninterrupted circuits as well as non-galvanic couplings. Even cancellation of free space noise and unwanted radiation on power cable communication systems is part of the present invention. Perhaps the most interesting aspect of the invention is that all implementations allow low cost system realisations.

The facilitation for communication networks generally by the present invention to use higher carrier frequencies, multiple channels and bi-directional, one-port repetitions, also allows non-carrier or low frequency carrier based communication protocols to utilise the present invention. As an example, the Ethernet protocol may be modulated onto carriers in a manner similar to the use of cable modem protocols. Long Range Ethernet is a particularly interesting protocol for use with the invention because it uses QAM similarly to cable modem systems, Docsis and EuroDocsis. Even PLC protocols and signal formats may be used in a similar manner. The invention can be used for most communications protocols and modulation types. Proprietary communication protocols and modulation schemes may be applied. Examples modulation types and communication protocols are frequency spread spectrum OFDM, time frequency spread spectrum DSSS, QAM, QPSK, and protocols like cable modem DOCSIS and EURODOCSIS, IEEE802.11x, Bluetooth, TETRA, GSM, GPRS, GSM, UMTS, IP telephony and other types of telephony. Depending on the requirements, the signals handled by the invention may be double or single side band. Again, being able to use high frequencies where attenuation in the medium is high attenuates reflections to negligible levels, which may be a very important facilitation by the invention.

By facilitating wide bandwidth communication on global infrastructures like power grids circuits, new concepts for mobile communication and other becomes possible. As an example, the everywhere present power infrastructure allows the invention to realise a larger number of reduced area communication cells at greatly reduced total system cost and improved overall coverage. Wherever power cables or wires are present, the invention makes it possible to provide backbone infrastructure for a base station of as an example a UMTS base station. When used as wireless repeaters the invention also makes it possible to extend the radio coverage of base stations at very reasonable costs.

### SHORT DESCRIPTION OF THE FIGURES.

The present invention is described in more detail in the following with examples and references to the appended drawings, where

FIG. 1 shows the block diagram of a typical transponder system corresponding to known technology comprised by an analogue and a digital unit;

FIG. 2 shows a block diagram of an implementation of the first aspect of the present invention, where the simplest possible method of retransmission based on the present invention is shown;

FIG. 3 shows a block diagram of an implementation where a separate oscillator signal is introduced in order to improve control with bandwidth, unwanted radiation and energy consumption of the transponder;

FIG. 4 shows a block diagram of another design version where a detector and amplification for reception (down link) is arranged and where various levels of reception may be controlled by an introduced TR switch;

FIG. 5 shows a block diagram of still another design version, where the transponder is introduced in a microwave ASIC due to the simplicity of the microwave technical concept which the present invention is based upon which again permits simple and low cost realisation in microwave ASIC or a MMIC;

FIG. 6 shows a block diagram of an implementation that diverts from the design version in FIG. 2 in that an antenna is replaced by a different coupling element as well as a filter in the signal path to and from the oscillator is shown as a split, bi-directional filter;

FIG. 7 shows a block diagram illustrating the second aspect of the invention where a super regenerative transponder works as part of network architecture;

FIG. 8 illustrates de various signal transmission mediums that a transponder in a network may be connected to, FIG. 9 shows a special design version a transponder according to the present invention aimed at co-operating with a network;

FIG. 10 show an application of a number of transponders together in various ways in connection with network solutions;

FIG. 11 shows an application of a number of transponders together in still another embodiment; and

FIG. 12 shows an example of distribution of transponders along transmission lines or waveguides to increase capacity of the line.

FIG. 13 shows one method of achieving desired signal dynamics and bandwidth with the regenerative transponder at the same time as isolation between port terminal and the regenerative circuit is improved.

FIG. 14 shows one method of realising a one-port frequency transposing transponder or amplifier using conventional techniques which is applicable to the present invention when sufficient and reliable power is available as in certain areas of power line communication. FIG. 15 shows how bi-directional frequency transposition and one-port bi-directional amplification may be applied to symmetrical communication systems like IEEE802.11b. The same principle can be applied to asymmetrical communication using different up and down link frequency bands simply by adding redundancy in the implementation.

FIG. 16 shows how the present invention for asymmetrical communication, i.e. cable modem signals, partly or largely can be realised using directional coupling and frequency transposition. When sufficiency power is available, large amplification and directional coupling can be used to sustain signal to noise ratio using higher carrier frequencies on i.e. lossy power lines and cables.

FIG. 17 shows an embodiment of the invention where radiated signals and noise from an antenna or probe arrangement can be combined with the directly coupled signals to cancel radiated signals and common mode noise and interference in a cable and wire based system.

FIG. 18 concerns power grid communication access systems and contain an overview drawing of a novel type access system facilitated by the invention. A novel solution for medium voltage stations is shown plus a drawing of a novel solution for applying gain in distribution boxes and other termination points are shown.

FIG. 19 mainly concerns some methods of the invention of how couplers are connected to medium voltage cables, using transformers as a capacitor network to pass high frequencies through the transformer as well as galvanic, differential couplers with low voltage cables.

### DETAILED DESCRIPTION

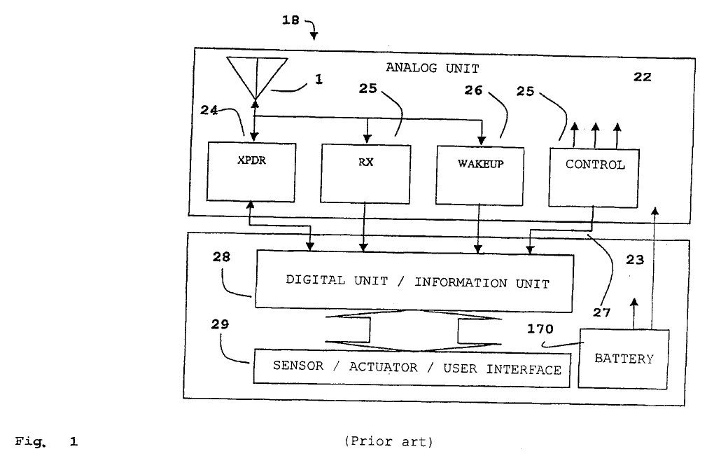

In FIG. 1 is shown a typical transponder device 18 consisting of an analogue 22 and a digital 23 unit. The analogue part has an antenna 1 and a radio frequency transponder 24. The transponder 24 may be a modulated transmitter or a transponder capable of retransmitting the incoming carrier with a modulated response from the transponder 18. It is often designed to include a down link receiver 25 and a wake up receiver 26 as well as a control unit 25. When the digital part is included in the transponder device 18 it will consist of an information unit 28 normally combined with an interface 29. The transponder device 18 also consists of a power supply most commonly made up of a battery 170.

The most important part of the transponder device 18 is the transponder 24 for up link. The down link information receiver 25 is either a separate part of the transponder device 18 or is partly integrated with the wake up receiver 26. The digital unit 23 information device 28 identifies the transponder device 18 and the digital unit may also possess abilities of processing information as well as perform control of functions in the analogue unit 22 through a control interface 27. The digital unit 23 may also contain a physical interface 29 towards user, sensors or actuators.

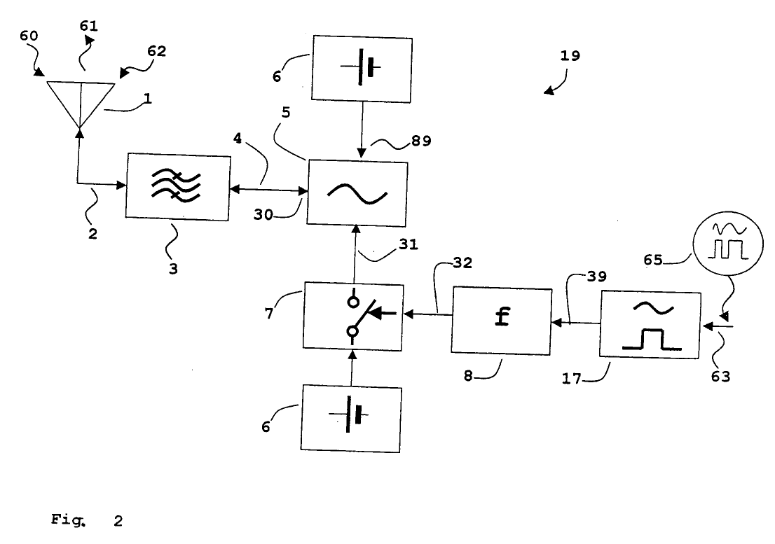

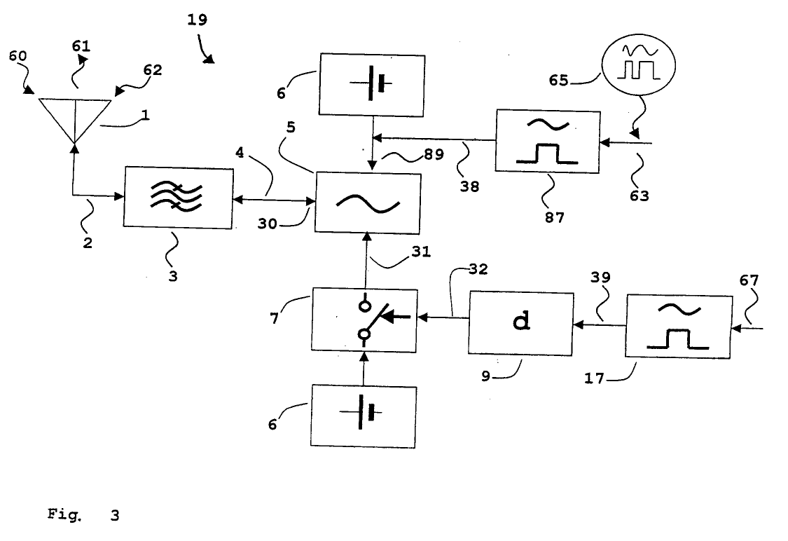

In FIG. 2 a block diagram of a transponder 19 not including any information unit and according to the present invention is shown and where a simple method for retransmission with the help of the present invention is illustrated. The solution shown for the present invention may be used both for signal repetition, interrogation and transmission. It encompasses a bi-directional coupling 2 between antenna 1 and a band pass filter 3, and a bi directional coupling 4 being a single or dual signal path leading to a regenerative circuit 5 that contains separate parts or is integrated in a circuit which, depends on the requirements of the transponder 19.

The regenerative circuit 5 may in principle contain a random type oscillator circuit which again is identical to a destabilized amplifier, and the connection point involves in principle any point or points in the oscillator where the necessary coupling of energy in and out of the regenerative circuit is achieved. This gives a regenerative or super regenerative amplification which is sufficient for the purpose of which the transponder is intended. A bias circuit 6 supplies bias to oscillator 5 that may contain a bipolar or field effect transistor in transponders from the short wave ranges and all the way up to the cm and mm wave ranges (microwave). Regenerative circuit 5 will in the case of an oscillator only consist of one transistor, but may in principle consist of more, like when resonating elements other than coils and capacitors are used or it may contain an integrated circuit, i.e. a MMIC (microwave integrated circuit). Likewise the regenerative circuit 5 may also consist of a number of oscillators to achieve bandwidth and gain. An electronic control element 7 that may be comprised by a diode or transistor has two main positions. One gives the oscillation conditions while the other quenches the oscillating state. The use of such a switch in connection as shown is called “quenching”. The working principle of the transponder in the case of a regenerative oscillator is that the control element never permits the oscillator or oscillators of regenerative circuit to oscillate continuously.

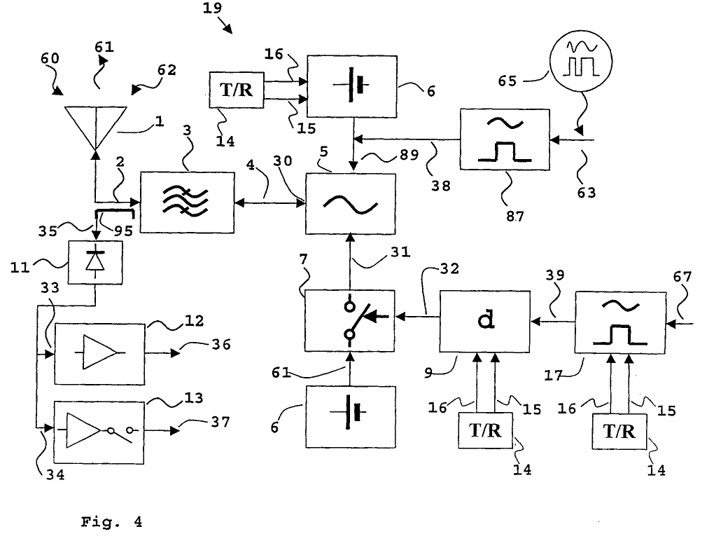

In FIG. 3 a block diagram is shown with a second example of the present invention, with a transponder 19 where separate modulators 87, 17 are introduced for modulation of information 65 respectively switching 31, to improve control with the transponder 19 bandwidth, unwanted radiation and current consumption. The modulation or quenching function 38 may also serve as a local oscillator signal and thus add a second conversion or heterodyne function to the regenerative circuit 5 the purpose being to allow the bandpass filter 3 to have a frequency pass band different to that of the regenerative circuit 5. A signal 39 or 67 may be a signal from a separate oscillator, processor, phase locked loop (PLL) or a similar arrangement that is able to generate a high frequency signal, or it may in less critical applications be generated as a self oscillation in the oscillator 5 (self quenching) which also allows simple synchronizing of the quench action by some function superimposed on the received signal 60, 62. Separate modulators for information and switching makes it possible to use a pulse forming network 9 together with the frequency of the signal 39 and the function of the modulator 17 can control various properties of the transponder 19 like shaping of the high frequency pass band for the regenerative circuit 5.

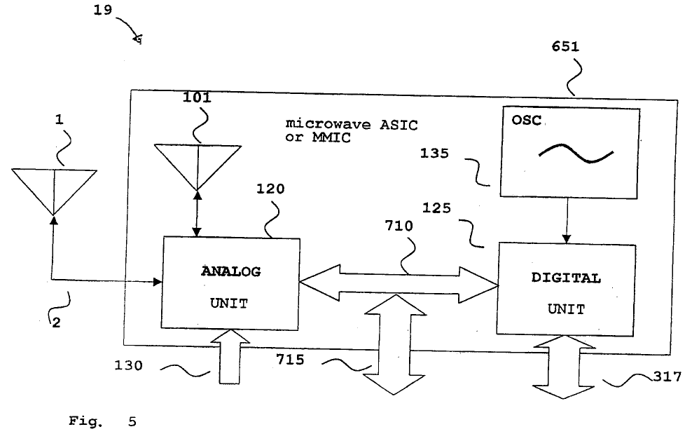

FIG. 4 shows a block diagram with the third design version of the transponder according to the present invention, where a detector 11 is introduced as well as an amplifier 12 for receiving (down link), where the transponder still can be used both for signal repetition, interrogation, transmission and reception. The solution shown includes also a frequency or level discriminating amplifier 13 for wake up and the design version also includes a T/R (transmit/receive) switch.

The working principle of reception of information (down link) is that a signal that is connected relatively loosely to the signal path 2, is led by the help of a coupler 95 to a detector 11 (i.e. a Schottky diode) that demodulates the modulated signal received on the antenna 1 and is amplified by the oscillator 5. The receiving circuit then enjoys the selectivity of the bandpass filter 3 to reduce intermodulation distortion caused by the output from regenerative circuit 5.

FIG. 5 shows a block diagram of a fourth design version of the transponder according to the present invention, here shown as an “analogue unit” 120 where the invention is implemented in a microwave ASIC (customer specified integrated circuit) 651 or MMIC (microwave integrated circuit). The implementation is comprised by either the radio frequency transponder 120 only or it contains a digital unit 125 as well, a clock oscillator 135 and input and output terminals.

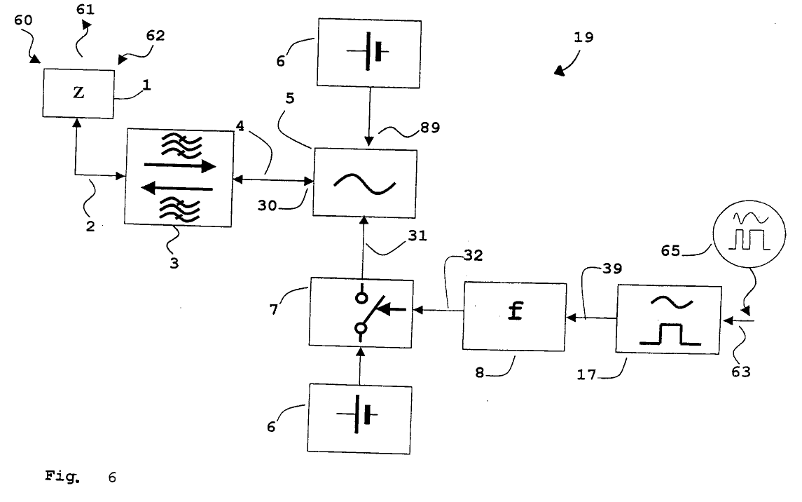

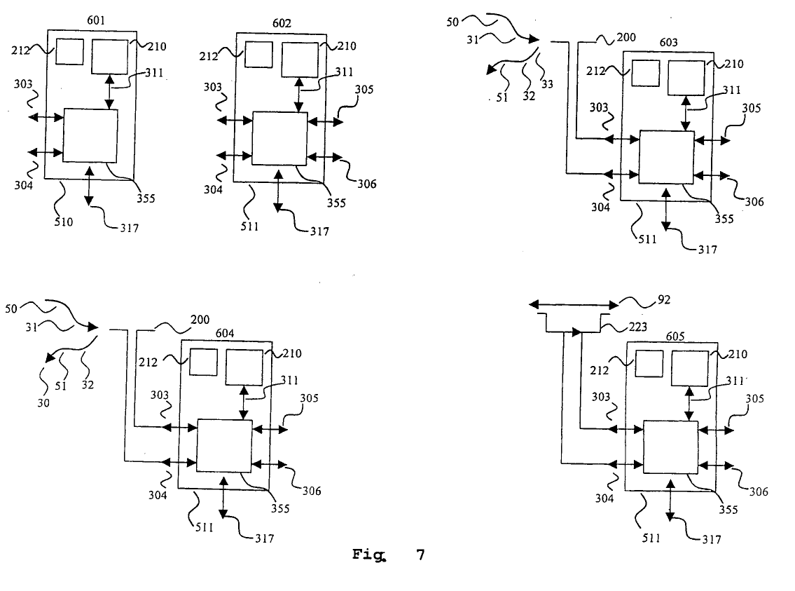

FIG. 6 shows an implementation that is fairly similar to the example shown in FIG. 2 and may be similar to the examples shown in FIG. 3 and FIG. 4, but it is shown that the antenna 1 is generalised as a coupling element of a more general type. Moreover is shown a special type filter 3, namely with possibilities for differing filter characteristics of the two signal paths to achieve a frequency shifted retransmitted signal. This is sometimes known as frequency transposing, transposition or conversion.

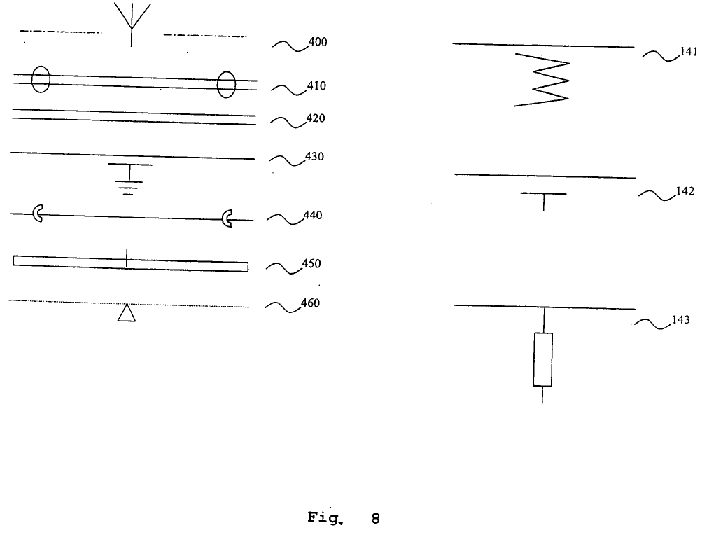

FIG. 7 The function generator function may include a secondary quenching or modulating signal or carrier which will allow the quenched oscillator 18, 19, 5, 601-606 to act as a frequency up- or down-converter in addition to the regenerative amplification. This allows the regenerative function to take place in a frequency band which is favourable for achieving the desired quench frequency spacing and dynamic properties, while the communication band may be at any frequency sufficiently spaced from the regenerative circuit 5 frequency pass band. Added input isolation also results from the frequency band differences, input filter 3 and selectivity of regenerative device 5, 601-606. Thus, the frequency up- or down-converted amplified signal out will be in-phase with the same signal in due to perfect symmetry. External synchronising of the frequency source is achieved by synchronising to an external synchronising signal 31 or by synchronising to the implicit quench signal 32 of a corresponding transponder 511 in the network.

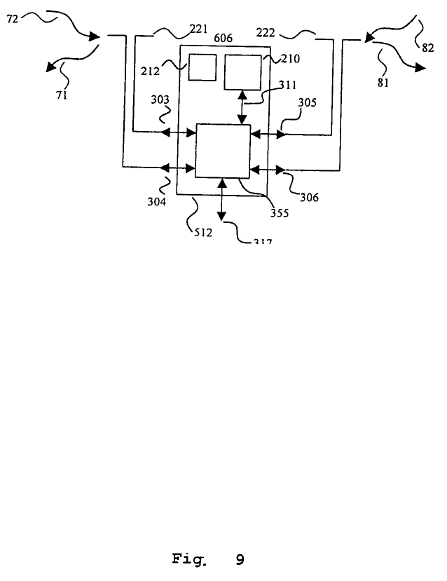

FIG. 8 shows, in accordance with FIG. 7, the various mediums and transmission medium interface methods that the invention offers novel usage of, in particular concerning regenerative cascaded gain, including:

Free space propagation 400 in vacuum, gas, liquids or solid material with the help of antennas or probes,

Transmission line 410 consisting of a multi-lead electrical cable or cable like infrastructure, where more than two wires allow differential transmission line modes for improved common mode rejection

transmission line 420 consisting of an open, electric line or an arrangement corresponding to an open electric line which contains two or more conductors and that are twisted or not twisted, metal structures comprising a transmission line, transmission line or a line system comprising a wandering wave antenna line system 430 consisting of on or more wires and where the transmission wave is referenced to earth, and where both differential and single wire excitation is possible. Examples of wandering wave antennas are the horizontal V, the Rhombic and the Beverage antennas.

transmission line 440 performing as a wave guide with open surface, a so called Lecher Wire where, the wave when, having a short wavelength, is kept trapped near the wire and experiencing low attenuation and can be excitated and tapped using known methods, transmission line 450 which, is a closed waveguide and may be resembled by a metal pipe, and transmission line 460 being an optical waveguide as the transmission medium and possibly to serve as a none galvanic connection to an electric medium.

Connections to lines used in the invention may be realised as differential (symmetrical) or asymmetrical couplings with the help of inductive (magnetic, Hs field) arrangements 141, capacitive arrangement (electric, E-field) 142, resistive arrangement 143 (galvanic coupling) or, a combination of the three as with transmission lines in the form of micro strip. The coupling arrangements of the types 141, 142 and 143 may in some cases be used alone or in combination to power the transponders from the hosting infrastructure. In practice, the non-galvanic couplings make take different forms. A novel example of a type of capacitive 142 coupling is the capacitive probe connections of “Elastimold” high voltage power cable terminations in connections with the high signal gains offered by the present invention. Another novel example of capacitive coupling 142 in the invention is the use of cable shields as the coupling capacitor to the inner conductor or conductors of the cable. An “antenna” within a high voltage compartment is still another example of interfacing made possible by the present invention. For signal excitation in the invention, the antenna is more efficient as a near field antenna in the form of a magnetic loop 141 which may also provide another novelty of the invention by easily allowing differential coupling to two phases of a three phase cable termination. A small, self powered transponder placed directly on a high voltage power cable termination is yet another example of the invention providing non-galvanic coupling to the outside world or for interconnections in infrastructures.

According to the invention all couplings to and from different mediums as shown in FIG. 8 may concern the object of maintaining the signal along the path in the medium, excitation of the medium or output from the medium

FIG. 9 shows a transponder 512 in accordance with FIGS. 7 and 8, where an output 305, 306 is defined in the regenerative circuit 355 making the port 303, 304 an input or both input and output, while the port 305, 306 is an output with a higher level and input with lower sensitivity. The arrangement should serve to achieve a large dynamic signal by utilising signal gain and output level capability of the regenerative circuit 355 which possibly also contains a high frequency gain block to for the intended regenerative dynamic range. The ports 303, 304 and 305, 306 have arrangements 221, 222 connected for reception and transmission of signals for retransmission 71, 81 of information and or reception 72, 82 and transmission 71, 81 of information and possibly reception 72, 82 of synchronising/locking 72, 82 and possible transmission of synchronising/locking 71, 81. The coupling arrangements 221, 222 may be interconnected with a directional coupler or utilise the isolation of the medium to which arrangements 221, 222 are coupled.

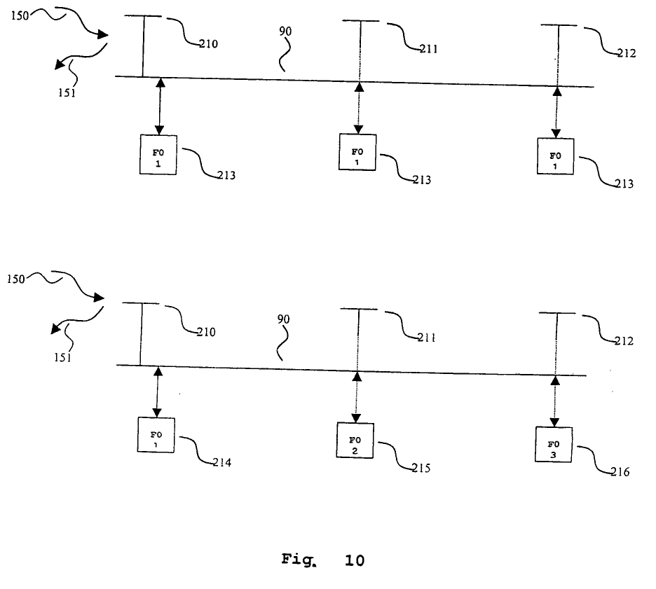

FIG. 10 shows an embodiment of the invention where a number of transponders or regenerative circuits 213 of the synchronised or none synchronised type, in order to improve dynamic characteristics of signals in one or more directions 150, 151, may be connected together in a coupling arrangement 210 with the help of a common coupling arrangement 90 or with the help of separate coupling arrangements 210, 211, 212 having attenuation between them and may constitute various points along a transmission medium or path. Correspondingly an embodiment of the invention is where a number of transponders or regenerative circuits 214, 215, 216 are arranged to increase bandwidth and dynamics and may be connected together to a coupling arrangement 210 with the help of a common coupling 90 and thus may constitute a multi pole, regenerative band pass filter. According to the use of transponders or regenerative circuits 213 together with 210, 211, 212 that similarly may be used with transponders or regenerative circuits 214, 215, 216 that may have differing specifications possibly to accommodate a number of channels, two-way architectures, different services, redundancy or other purposes served by a plurality of channel characteristics.

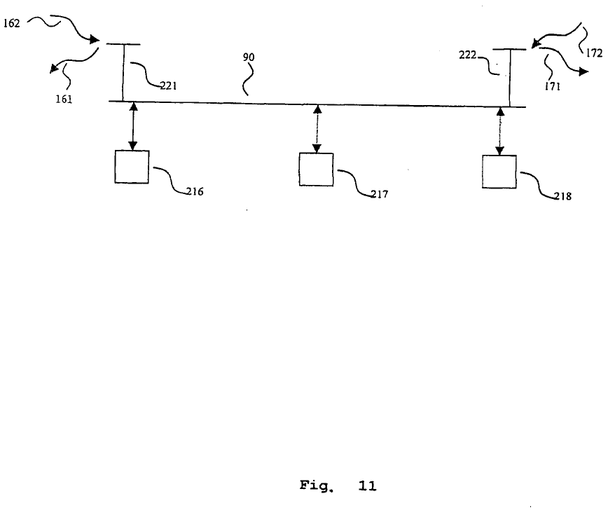

FIG. 11 shows, in accordance with the invention how a number of transponder units 216, 217, 218 may be connected together with the help of a common coupling or transmission line 90 allowing the coupling arrangements 210, 222 to transmit signals 161, 162 between a physical position 221 and signals 171, 172 on a different physical location 222, for example from one room 221 to another room. The physical locations 221, 222 or any number of physical locations may also be in free space using wireless transmissions and can facilitate communication when range is excessive or in shadow zones.

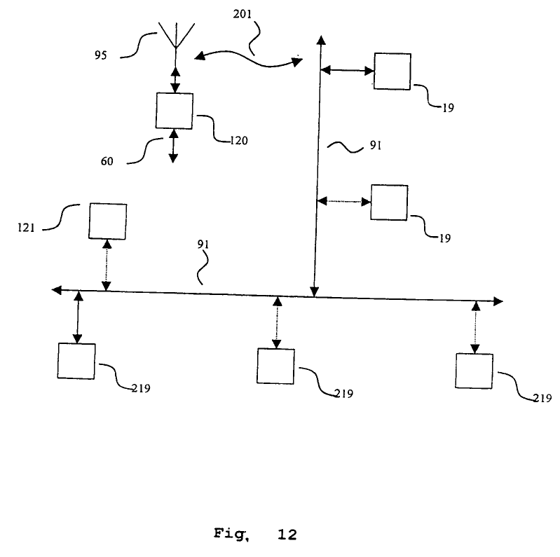

FIG. 12 shows a general example wherein the invention provides a novel solution to transforming a cable or wire grid into an efficient signal network able to accommodate high frequency signals over long distances. Regenerative circuits 219 representing transponders or repeaters are distributed across the infrastructure grid 91 serving as transmission lines. Galvanic or none galvanic couplers 121 may be inserted at any suitable point across the grid as inputs or output of the grid. With structures of a closed nature as with shielded cables, transponders 219 are most conveniently inserted at existing termination points as in distribution panels and the like. In some cases, using a transponder 120, the input, or output or both of the grids may be served by a wireless coupling using an antenna arrangement 95. The invention, using transponders 219 is also suitable for placement using penetration of for example a cable, using galvanic or none galvanic coupling.

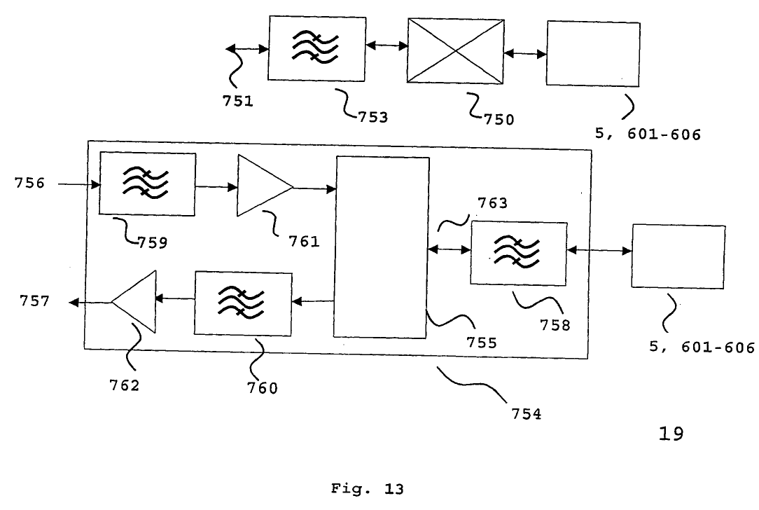

FIG. 13 shows one example of another embodiment of the present invention in connection with FIG. 7 where a secondary quench signal achieved an in-phase, bidirectional heterodyne function. The shown implementation of the transponder offers added input isolation at the expense of some complexity. Desired dynamic properties will only be achieved if the bidirectional frequency converter 750 is arranged to present equal and opposite phase shift in between the port 751 for incoming respectively outgoing signals and the regenerative device 18, 19, 5, 601-606. The simplest way to achieve this is using a single diode mixer, i.e. a Schottky diode. Sufficient filtering may be achieved using bandpass, highpass or lowpass filtering 753. Frequency and phase drift in the bi-directional frequency converter 750 will be automatically compensated when the bi-directional symmetry is properly sustained as with a simple, single diode mixer. Where practicable from for instance a frequency standpoint, more elaborate mixers in the bi-directional converter 750, 754 may be used including balanced mixers which will improve characteristics. A more detailed description of the frequency converter 750 for increased signal dynamics 754 includes separate chains with amplifiers 761, 762 and bandpass filters 759, 760 for input and output signals respectively. Amplifiers 761, 762 may compensate for losses in the mixer circuit 755 and provide necessary output signal levels 757. The mixer circuit 755 may be a single balanced mixer with a local oscillator. Mixer circuit 755 may also contain separate mixers for input and output signals respectively for added signal chain isolation. Mixer circuit 755 may also contain additional combiner isolation on the bidirectional port 763. The bidirectional bandpass filter 758 greatly improves signal dynamics. Input 756 and output 757 may be connected to a directional combiner to realise a one port transponder or used separately where appreciable output to input isolation is available.

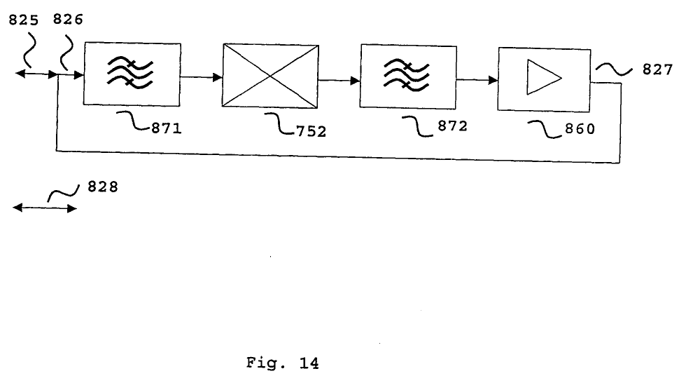

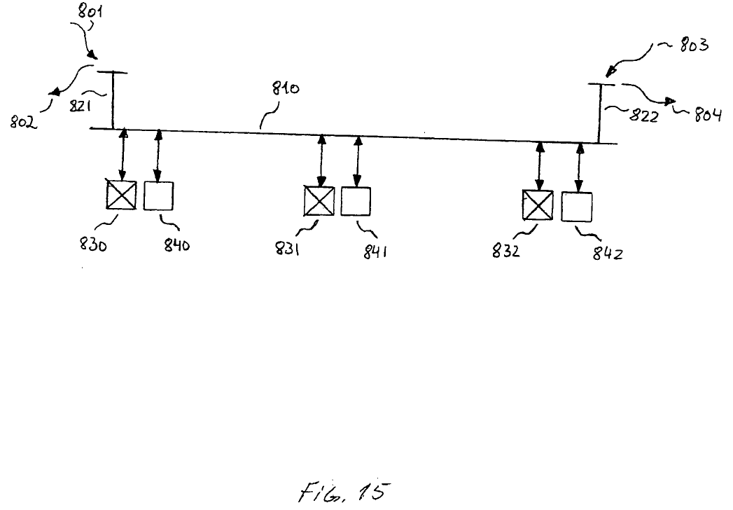

FIG. 14 shows an embodiment of the present invention which is a more costly, complicated and power consuming implementation with a function principally identical to the frequency transposing regenerative transponder. It consists of input filtering 871, frequency converter 752; output filtering 872 and a high gain amplifier 860. The output is tied directly or via a directional combiner hybrid to the input 826 to present a frequency transposing one-port amplifier at the terminals 825. The application hereof may be in power cable or wire systems as well as wireless systems to increase noise tolerance, adaptation to varying cable types, lengths and losses using one-port amplification including a frequency shift. It may utilize sharp, even loss filters to allow the frequency converted channel to be adjacent to the input channel. It is well suited to sustaining the signal to noise ratio on a transmission line like a power cable without exceeding critical radiation levels. As with other super heterodyne solutions, it may be realised as a double heterodyne and thus allowing so-called pass band tuning which can be controlled by a variable oscillator and be easily remote controlled. The output 827 may in stead of being directly tied to the input 826 and a common point 825 be connected separately to a point 828 in the infrastructure or communication medium which exhibits some isolation to the firstly mentioned point 825.

FIG. 15 shows how bi-directional frequency transposition 830-832 and one-port bi-directional amplification 840-842 may be applied to symmetrical communication signals 801, 802, 803, 804. The transmission medium 810 may be a lossy power line cable connected to other mediums through 821, 822, i.e. other cables. The present invention explains the possibility of using one-port frequency converters 830-832. Frequency converters 830-832 may also be multi-port frequency transposition devices provided that the transmission medium 810 can be interrupted. Long or large attenuation signal paths can be compensated with any number of intermediate devices 831, 841. The same principles can be applied to asymmetrical communication using different up and down link frequency bands simply by adding redundancy in the implementation. The application both for asymmetrical and symmetrical communication systems may be in power cable or wire systems as well as wireless systems to increase noise tolerance, adaptation to varying cable types, lengths and losses using one-port amplification including a frequency shift. It is well suited to sustaining the signal to noise ratio on a transmission line like a power cable without exceeding critical radiation levels.

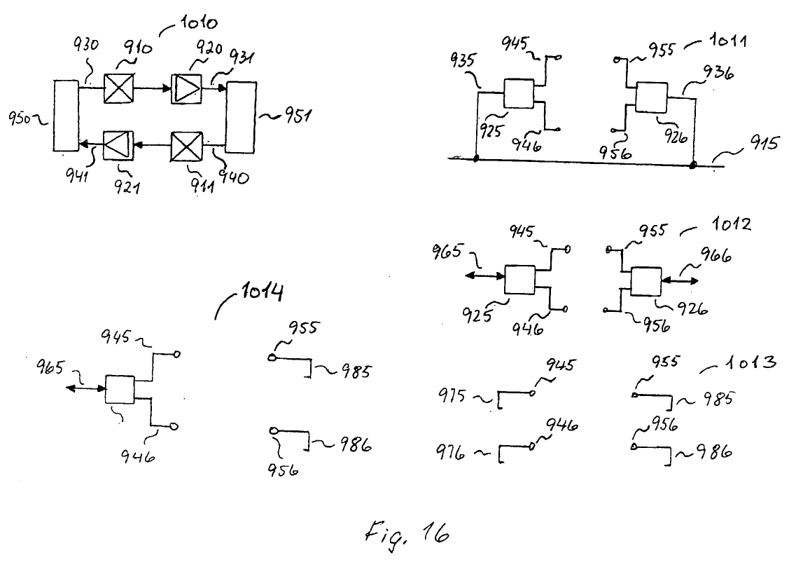

FIG. 16 shows how the present invention for asymmetrical communication, i.e. cable modem signals, partly or largely can be realised 1010 using directional coupling 950, 951 and selective frequency transposition 910, 921 in differing frequency bands. When sufficient power is available, low cost large amplification and directional coupling can be used to sustain signal to noise ratio using higher carrier frequencies on i.e. lossy power lines 810 and cables 810. This embodiment of the invention, due to the various possible connection schemes 1011-1014, overcome at very low costs the problems of earlier industry attempts to achieve large bandwidth over great distances. Using high carrier frequencies, efficient coupling and isolation can be accomplished by any of the coupling schemes 1011-1014 whereas the allowable high gain amplification compensates for the high losses at carrier frequency. Frequency bands can be chosen for the current lossy transmission medium, i.e. power cable and to allow signals in both directions to operated undisturbed and away from low frequency noise as well as benefiting from attenuated reflections and reduction of group delay ripple. In the first connection scheme 1011, combined attenuation from directional couplers 935, 936 and bandpass, lowpass or highpass filtering in 1010 allows the common ports 935, 936 of the couplers 935, 936 to be tied together and yet achieving useful gains while attaining unconditional stability. Isolation ports 945-946, 955-956 are tied to inputs and outputs 930-931, 940-941 of 1010. The medium 915 may be a lossy power cable. Connection scheme 1012 shows a similar implementation where the transmission medium allows interruption. Connection scheme 1013 uses none galvanic coupling 975, 976, 985, 986 to the transmission medium, which may be one or more power line cables. The couplings 975, 976, 985, 986 can typically be of the capacitive type 142, i.e. the capacitive test coupling in “Elastimold” power line stations or stray capacitive coupling or “antenna” arrangement within a high voltage power switch cell compartment. An antenna arrangement in the invention may efficiently take the form of a magnetic loop antenna which also facilitates a novel solution for symmetrical, differential excitation and tapping of high voltage and medium voltage cables in particular. A novel approach of fibre optic cable based interface to high and medium voltage cables is fascilitated by the invention where the regenerative gain block used between the high voltage and the fibre cable may be optically powered through the fibre cable or by tapping power from the high voltage inductively or capacitively and at the same time conveniently can provide bidirectional capabilities whereas two such arrangements may provide differential mode. Connection scheme 1014 utilises a combination of schemes 1011-1013. This is especially applicable to the transition of two-way signals between high voltage power cables and low voltage power cables. In this case, connections 985, 986, i.e. at the high voltage side, assist isolation by not being tied together, while connection 965 may be routed to one or more 220 Volts power cables using interconnecting coaxial cables.

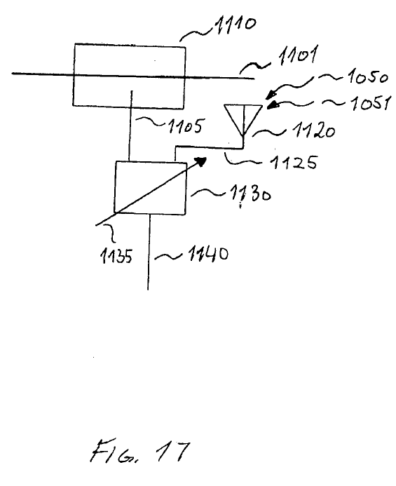

FIG. 17 shows a novel embodiment of the invention radiated signals 1050 and noise 1051 from a noise probe arrangement 1120 can be connected via a combiner 1130 with the directly coupled signals and noise 1105 to cancel radiated signals and noise pick up in a cable 1101 based system using a connections scheme 1110 which may be of the types 1011-1014. The combiner 1130 may be of an analogue or a digital signal processing type and allows common mode noise cancellation possibly by automatic adjustments of phase and amplitude relationships to be adjusted 1135 for minimum radiated system signal levels and minimum system noise on any tapping or injecting signal path 1140. The probe arrangement 1120 may include several probes or antennas whereas the H-field probe will be most efficient for common mode immunity in transformer stations and E- and H-field probes, antennas or emitters may be necessary for plain wave missions and immunity. FIG. 17 deals with a problem mostly encountered in power grid old transformer installations. It has less relevance to power grid field distributions that mostly have metal or steel shielding not only for screening but for personnel and public safety purposes as well. _The passive part of the probe or probes 1120 may be constituted by parts of a cable shield or similar.

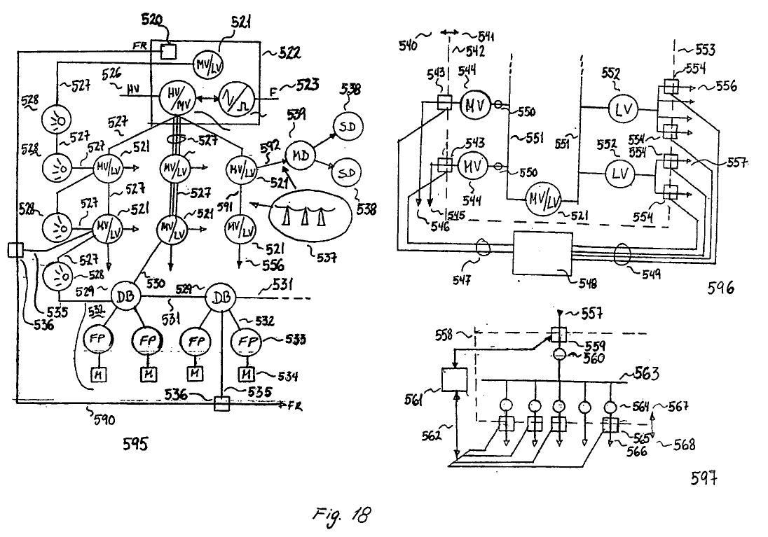

FIG. 18 shows different embodiments of the invention and in 595 is an overview drawing of a novel type access system facilitated by the invention and which may use one or more of a number of modulation types and communication protocols and it may for example be cable modem based. The invention facilitates the entire structure of power cables and wires in a community being used as a communication network through the various embodiments of the invention allowing cascaded analogue gain, interconnections, bi-directionality and optimal use of the high frequency capacity of the infrastructure. This includes high 526 to medium voltage transformer stations 525, medium to low voltage transformer stations 521, three phase medium voltage shielded ground cables 528, three or single phase low voltage cables 530, 531, 532, 556, medium voltage mast mounted 537 lines 591, low voltage mast mounted 537 cables or lines 592, low voltage distribution boxes 529, home fuse panels 533, building main distributions 539 and sub distributions 538, street light masts 528 and cabling 527 and may be combined with fibre ring infrastructure 590 using analogue fibre interfaces 536 to distribute 535 signals one or two-way at strategic points of the power grid infrastructure in a HFC (Hybrid Fibre Coax) manner. Customer premises equipment (CPE) 534 may be installed in or near the fuse panel. The digital to analogue and analogue to digital equipment (AID-D/A) 524 may be installed at any point in the power grid architecture and sometimes most favourably and economically in the high to medium voltage transformer station 522 where one fibre connection 523 may serve the entire access network. The fibre ring 590 may also distribute digital signals to various A/D-D/A 524 equipment at various locations in the system when this is economical. In FIG. 18, 596 an embodiment of the invention shows how signals may bypass the transformer 521 in a medium voltage transformer station 596. Unidirectional or bidirectional regenerative repeaters 548 according to the invention provide necessary and stable signal gain as well as multi channel capability passed the transformer between any number of couplings, preferably of the differential kind which may be in the form of baluns, 543 and 554 in the medium voltage compartments 544 and the low voltage distribution 553, respectively. The rails 544 with any switching arrangement may be of the open type, shielded type or the Elastimold or similar type. Accordingly, 597 is another embodiment of the invention where regenerative gain 561 and connectibility 559, 565 may be applied to a connection box, distribution panel or any other cable termination point to provide a high quality analogue signal path, unidirectional and bidirectional between point 557 and points 566. This solution adds the inherent, limited high frequency isolation always present through straps, fuses or other 564 and rail 563 and provides stable gain through the regenerative analogue gain in 561.

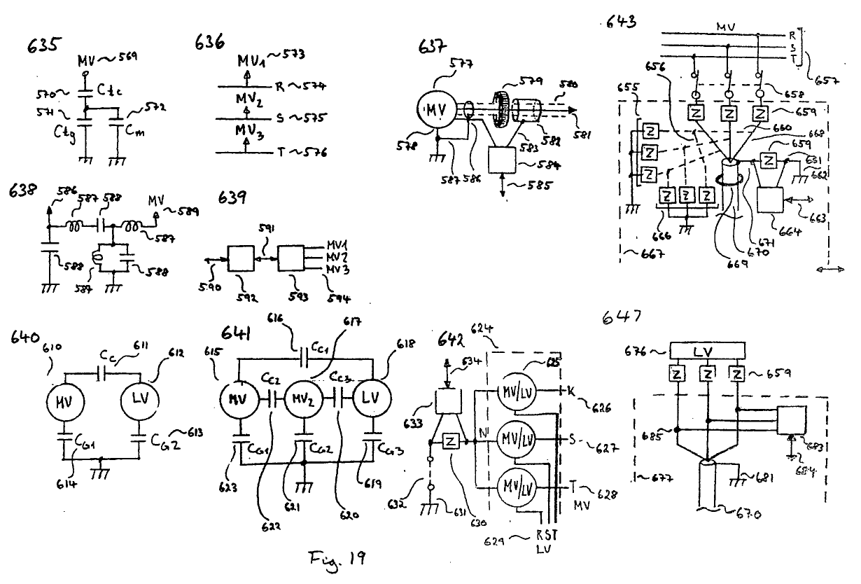

FIG. 19 concerns various embodiments of the invention of passing high frequency signals to and from a medium voltage or high voltage cable in conjunction with applying analogue gain in a power grid communication system consisting of various voltage levels and utilising the cascading of cables of different voltages. An equivalent diagram of an Elastimold or similar system voltage probe point is shown 635 which may be used in the invention, especially as a signal sensor point. A suitable network 638 may be used in conjunction with the probe point 635 or signals may be tapped directly into a high impedance preamplifier. Excitation may be performed more efficiently using stray capacitances on high frequencies with the embodiment of the invention-in 637. The cable 581 may be terminated in a transformer 577 where intrinsic, efficient stray capacitances for high frequencies exist between centre conductor 581 and the high frequency common potential 578 or it may utilise stray capacitance between the cable shield and the inner conductor at the termination end of the cable. This allows excitation or even tapping to take place between the a capacitor sleeve clamped on the cable 582, 583 and the safety grounding wire 586 of the cable shield using a two terminal coupler 584 which is connected to the rest of the signal path of the installation. A toroid core clamped on the cable 579 may improve the principle. The coupler 584 may also be connected similarly via windings on the toroid 579. This toroid may also be clamped on the grounding wire associated with the termination of the cable shield 580 or toroids may be used in both places. In a three phase installation 636 two cables 574-576, may be used separately for increased capacity or in pairs for differential modes. The coupler 584 may also be connected between the cable shield safety grounding wire point 586 and the high frequency common potential 587 in stead of using a sleeve 582 and a toroid may be clamped on the mentioned grounding wire and the coupler may also be connected to windings on the lastly mentioned toroid and in this way utilising the intrinsic stray capacitance to the common potential in the transformer 577. Stray capacitances within the transformer 640, 641 may also be used as coupling networks to pass a high frequency signal through the transformer, possibly using matching network similar to the kind in 638. A high frequency signal may also be passed though a transformer 642 by using the impedance or increasing the impedance 630 between the neutral terminal of the transformer 624 and ground and connecting a coupler 633 across this impedance. An embodiment of the invention 643 which does not allow differential mode but which still is useful in medium an high voltage compartments that are well shielded and exhibits low noise utilises intrinsic stray capacitances 655. It may also utilise introduced stray capacitances 666. Series impedances, possibly in the form of clamp on magnetic materials may be introduces 659 to reduce influence from low loss open rails 657. The stray capacitances allow excitation and tapping through a coupler 664 connected between the cable shield grounding 662 and the cable shield and the grounding high frequency impedance 659 may be increase using clamp on magnetic material. The high frequency energy is then coupled to the cable at the shield and at the inner conductors via the stray capacitances 655, 666. Galvanic coupling to two and three phase low voltage cables as shown generally in FIG. 18 may use differential mode as in the embodiment of the invention 647 through a coupler 683 which may contain one or more baluns using a pair of the phases 685 of the low voltage cable 670 and clamp on magnetic material 659 may be used to appreciably increase isolation to the low voltage rail or any other termination devices which the cable is connected to.

1. Transponder for amplification of a received signal (60) into a receiving element (1), e.g. an antenna, to a signal (61) for retransmission, where the retransmission signal (61) possible can have information superimposed, characterized in that the transponder comprises, as an amplifying element, a quenched oscillator (5).

2. Transponder according to claim 1,
characterized in that the oscillator (5) is a superregenerative oscillator.

3. Transponder according to claim 1,
characterized in that the oscillator (5) exhibits negative resistance (30) for the received signal (60).

4. Transponder according to claim 1,
characterized in that the oscillator (5) is connected to a quench switch (7) arranged for coupling a quench signal (31) into the oscillator.

5. Transponder according to claim 1,
characterized in that the oscillator (5) is operative to deliver the retransmission signal (61) onto the same signal path (2, 3, 4) as the path followed by the received signal (60) from the receiving element (1), which signal path (2, 3, 4) thus is bi-directional.

6. Transponder according to claim 1,
characterized in that the oscillator (5) comprises a resonator element of any type, but with a Q factor suitable to give the retransmission signal (61) large to very large amplification.

7. Transponder according to claim 4,
characterized in that the quench switch (7) is arranged to switch a bias voltage (6) to the oscillator (5).

8. Transponder according to claim 4,
characterized in that the quench switch (7) is operative to switch in and out an impedance that the oscillator (5) sees.

9. Transponder according to claim 4,
characterized by a modulator (17) which controls the quench switch (7) with a switching signal (32).

10. Transponder according to claim 5,
characterized in that the bi-directional signal path (2, 3, 4) between the antenna (1) and the oscillator (5) has additionally a band pass filter (3) included.

11. Transponder according to claim 9,
characterized in that the modulator (17) is operative to receive a modulator signal (63), which may be a information carrying signal, and to produce the switching signal (32) as a function of the modulator signal (63) whereby the quench signal (31) leads to superimposing of a modulation signal on the retransmission signal (61).

12. Transponder according to claim 9,
characterized in that the oscillator (5) is connected to an additional modulator (87) for submission of an information signal (38) to the oscillator (5) independently of the quench switch (7) and the firstly mentioned modulator (17), said information signal (38) being generated by the additional modulator (87) on the basis of an additional modulation signal (63) which contains the information.

13. Transponder according to claim 12,
characterized in that the switching signal (32) is a predetermined frequency that is from higher to many times higher than the highest frequency component of the information signal (38).

14. Transponder according to claim 9,
characterized by the inclusion of at least one transmit-receive switch (14) connected to at least one of a bias arrangement (6) for the oscillator (5), a modulator (17, 87) and a pulse forming network (9) for the switching signal (39, 32), for control of switching signal and bias voltage.

15. Transponder according to claim 10,
characterized by further having included a detector arrangement (11), like a Schottky diode, coupled high frequency-wise to the oscillator (5), preferably loosely coupled to the signal path (4) close to the oscillator (5), using a coupler (95), in such a way that the information carrying received signal (62) can be amplified by the oscillator (5) in order to increase the amplitude of a detected signal (33, 34) behind the detector arrangement (11).

16. Transponder according to claim 15,
characterized by the inclusion of an amplifier (12) connected following the detector (11), for amplification and possibly filtering of the detected signal (33) into an infosignal (36) of desired amplitude and dynamic properties.

17. Transponder according to claim 15,
characterized by the inclusion of a wake up circuit (13) connected following the detector (11), for utilisation of the detected signal (34) to produce a wake up signal (37).

18. Transponder according to claim 10,
characterized in that the band pass filter (3) in operative to filter out all side bands that result from the quench signal (31) frequency, to allow the retransmitted signal (61) to become a clean, amplified version of the received signal (60) thereby acheving an analogue relay link.

19. Transponder according to claim 10,
characterized in that the band pass filter (3) is bi-directionally divided and encompasses two directional filters, in order to achieve a retransmission signal with frequency shift.

20. Transponder according to claim 9 and 10,
characterized by integrating at least two of the transponder elements hereby stated: receiving element (1), band pass filter (3), further signal path (2, 4), oscillator (5), quench switch (7) and modulator (17).

21. Transponder according to claim 1,
characterized by being implemented as a customer specified, integrated circuit (ASIC, 651) with analogue circuits (120).

22. Transponder according to claim 21,
characterized in that the ASIC circuit (651) also incorporates digital modules (125, 135).

23. Transponder according to claim 21,
characterized by the ASIC circuit incorporating a duplex transceiver with or without frequency transposing.

24. Transponder according to claim 1,
characterized in that it is implemented as a microwave integrated circuit (MMIC, 651) using analogue circuits (120).

25. Transponder according to claim 1,
characterized in that the receiving element (1) is implemented as a coupling or probe to a transmission medium like a transmission line.

26. Transponder according to claim 1,
characterized in that the oscillator (5) is operative as a two port with an input and an output where the input is a signal sensitive point in the oscillator like a transistor base, gate, source or emitter, while the output is a point where highest possible energy level may be collected, like a transistor collector, drain, emitter or source.

27. Transponder according to claim 26,
characterized in that the twoport being coupled to an arrangement for directional attenuation, to utilize the total dynamic range of the transponder.

28. Transponder according to claim 26,
characterized in that the twoport is coupled to separate receiving elements and transmission elements.

29. Transponder according to claim 1,
characterized by a filter arranged to reduce harmonic overtones from the oscillator (5) quench frequency in the frequency range where the transponder sensitivity is largest, which filter is part of the oscillator or is a part (8) of a separate circuit connected to the oscillator (5).

30. Transponder according to claim 1,
characterized by an arrangement (87) for introducing secondary quenching as oscillations superimposed on the primary quench oscillation, at a point in the oscillator (5) where the oscillating conditions can be influenced.

31. Transponder according to claim 1,
characterized by a function generator (9) for asymmetrical control of the quench oscillation.

32. Use of at least one transponder in accordance with claim 1, in a wireless or wire-based network, the receiving elements (1) of the transponders being implemented as couplings or probes (141, 142, 143, 223) to network transmission mediums (92, 400, 460) like for instance transmission lines (410, 460).

33. Transponder system for wireless and wire-based networks, comprising a number of transponders (19, 601, 606, 213, 219) for amplification of a received signal (60) into a receiving element (1, 141, 143, 200, 220, 223), for instance an antenna or a probe, to a signal (61) for retransmission, where the retransmitted signal (61) may have information superimposed, whereby the transponders can work as intelligent or unintelligent connections in a network based on transmission through at least one of a number of possible transmission media (92, 400, 460), characterized in that each transponder comprises, as amplifying element, a quenched oscillator (5, 355).

34. Transponder system according to claim 33,
characterized in that at least one of the oscillators (5, 355) is of the superregenerative type.

35. Transponder system according to claim 33,
characterized in that at least one of the transponders is a multi-port transponder.

36. Transponder system according to claim 33,
characterized in that at least one of the transponders is operative to receive a quench signal from a dedicated quench generator (210).

37. Transponder system according to claim 33,
characterized in that at least two of the transponders are operative to receive a quench signal from a common quench generator (210).

38. Transponder system according to claim 33,
characterized in that at least two of the transponders are operative to receive a control signal for synchronisation of own quench generator (210)

39. Transponder system according to claim 33,
characterized in that at least one transponder is coupled to the network with the help of only one coupling element, which coupling element is identical to the receiving element.

40. Transponder system according to claim 39,
characterized in that the coupling element is an antenna or a probe in vacuum, gas or matter.

41. Transponder system according to claim 39,
characterized in that the coupling element is made up of a loose coupling to a line, in the form of an inductive, capacitive or resistive coupling, possibly a combination thereof.

42. Transponder system according to claim 35,
characterized in that at least one transponder is coupled to the network using two coupling elements, of which one is the receiving element connected to a first port of the transponder, and the second is a transmission element tied to a second port of the transponder.

43. Transponder system according to claim 42,
characterized in that at least one of the coupling elements is comprised of an antenna in vacuum, gas or matter, a probe in vacuum, gas or matter and a loose coupling to a line, in the form of an inductive, capacitive or resistive coupling, potentially a combination of these.

44. Transponder system according to claim 33,
characterized in that at least two oscillators or transponders are arranged inter-coupled, with common quenching, or synchronised quenching with controlled phase shifting between different quench signals, to achieve a long active cycle (duty cycle) for the transponder circuit.

45. Transponder system according to claim 33,
characterized by being incorporated in a wireless or wire-based network based on at least one type of spread spectrum technology.

46. Transponder system according to claim 33,
characterized in that the wireless or wire-based network that encompasses the transponder system, is based on transfer protocols in accordance with, or based on at least one of the communication systems UMTS, GSM, GPRS, TETRA, Ethernet including Long Range Ethernet, Bluetooth, wireless LAN, satellite access return channels, DOCSIS, EURODOCSIS and other cable modem protocols.

47. Transponder system according to claim 33,
characterized in that at least one of the transponders is powered via an inductive, capacitive or resistive coupling or a combination of these coupling types, from the transmission medium (410, 460) in question.

48. Transponder system according to claim 33,
characterized in that the oscillator (5) is a quenched oscillator exhibiting CW oscillation.

49. Use of a transponder system according to claim 33, in an asymmetrical communication system, as cable modems, whereby the communication system may use transmission medias other than coaxial cables.

50. Use of at least one transponder according to claim 1, in a radio positioning scenario using any type of positioning principle, in order to, with the aid of the transponder (19, 219), establish any geometrical place in the positioning scenario.

51. Transponder according to claim 1,
characterized in that a bi-directional frequency converter (750) is arranged to provide equal and opposite phase shift in between incoming respectively outgoing signal port (751) and the oscillator (18, 19, 5, 601-606).

52. Transponder according to claim 51,
characterized in that said frequency converter (750) is a single diode mixer, for instance a Schottky diode.

53. Transponder according to claim 51,
characterized in that a bandpass filter (753) is arranged in series with said converter (750).

54. Transponder according to claim 1,
characterized in that a series connection of an input filter (871), a frequency converter (752) and an output filter (872) is connected between an input terminal (825) and said oscillator (860), an output from said oscillator being tied to the input terminal (825) thereby to provide a frequency transposing one-port amplifier.

55. Transponder system according to claim 33,
characterized in that the transponders (830, 831, 832; 840, 841, 842) contain bidirectional frequency converters (750) or one-port bidirectional amplifier systems (825, 871, 752, 872, 860).

56. Transponder system according to claim 33,
characterized in that the transponders (910, 920; 911, 921) are inserted between directional couplers (950, 951) in an asymmetrical communication system, providing selective frequency transpositioning by means of frequency converters (910, 911).

57. Transponder system according to claim 33,
characterized b y at least one combiner (1130) for cancelling radiated signals and noise pick up from signals received from said at least one transmission medium (1101), said combiner (1130) being connected to receive signals (1105) and noise from said transmission medium (1101) via a transponder coupling (1110), and to receive radiated signals (1050) and noise (1051) via an antenna or probe (1120).

58. Transponder system according to claim 57,
characterized in that said combiner (1130) comprises an arrangement (1135) for adjusting phase and amplitude relationships between received signals.
